(19) United States
(12) Patent Application Publication
(10) Pub. No.: US 2025/0056385 A1
(43) Pub. Date: Feb. 13, 2025

(54) ACQUISITION OF NEW SATELLITE ASSISTANCE INFORMATION FOR SATELLITE SWITCH

(71) Applicant: Nokia Technologies Oy, Espoo (FI)

(72) Inventors: Rafhael MEDEIROS DE AMORIM, Aalborg (DK); Jeroen WIGARD, Aalborg (DK); Enric JUAN, Aalborg (DK)

(21) Appl. No.: 18/790,461

(22) Filed: Jul. 31, 2024

Related U.S. Application Data
(60) Provisional application No. 63/518,749, filed on Aug. 10, 2023.

(51) Int. Cl. H04W 48/10; H04W 84/06

(52) U.S. Cl. CPC H04W 48/10; H04W 84/06

(57) ABSTRACT

A method is provided that includes scheduling transmission of system information blocks (SIBs) including information elements with assistance information for a first aerospace platform, and a separate at least one information element with assistance information for a second aerospace platform. The first aerospace platform and the second aerospace platform are configured to provide respectively a first non-terrestrial network (NTN) cell and a second NTN cell that are quasi-Earth-fixed cells serving a geographic area for limited periods of time. The method also includes causing a user equipment in the first NTN cell to acquire the separate at least one information element with the assistance information for the second aerospace platform, during a period of time the geographic area is served by the first NTN cell, before the geographic area is served by the second NTN cell.

### TECHNOLOGICAL FIELD

The present disclosure relates generally to telecommunications and, in particular, to satellite switching in a non-terrestrial network (NTN) of a telecommunications system.

### BACKGROUND

A telecommunications system can be seen as a facility that enables communication sessions between two or more entities such as user terminals, base stations and/or other nodes by providing carriers between the various entities involved in the communications path. A telecommunications system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless telecommunications system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the telecommunications system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The telecommunications system and associated devices typically operate in accordance with a given standard or specification which sets out what the various entities associated with the system are permitted to do and how that should be achieved. Communication protocols and/or parameters which shall be used for the connection are also typically defined. One example of a telecommunications system is the Universal Mobile Telecommunications System (UMTS). Other examples of telecommunications systems are Long-Term Evolution (LTE), LTE Advanced and the so-called 5G or New Radio (NR) networks. NR is being standardized by the 3rd Generation Partnership Project (3GPP).

### BRIEF SUMMARY

Example implementations of the present disclosure are directed to telecommunications and, in particular, to satellite switching in a non-terrestrial network (NTN) of a telecommunications system. In this regard, the present disclosure includes, without limitation, the following example implementations.

Some example implementations provide an apparatus comprising: at least one memory configured to store computer-readable program code; and at least one processing circuitry configured to access the at least one memory, and execute the computer-readable program code to cause the apparatus to at least: schedule transmission of system information blocks (SIBs) including information elements with assistance information for a first aerospace platform, and a separate at least one information element with assistance information for a second aerospace platform, the first aerospace platform and the second aerospace platform configured to provide respectively a first non-terrestrial network (NTN) cell and a second NTN cell that are quasi-Earth-fixed cells serving a geographic area for limited periods of time; and cause a user equipment in the first NTN cell to acquire the separate at least one information element with the assistance information for the second aerospace platform, during a period of time the geographic area is served by the first NTN cell, before the geographic area is served by the second NTN cell.

Some example implementations provide an apparatus comprising: means for scheduling transmission of system information blocks (SIBs) including information elements with assistance information for a first aerospace platform, and a separate at least one information element with assistance information for a second aerospace platform, the first aerospace platform and the second aerospace platform configured to provide respectively a first non-terrestrial network (NTN) cell and a second NTN cell that are quasi-Earth-fixed cells serving a geographic area for limited periods of time; and means for causing an user equipment in the first NTN cell to acquire the separate at least one information element with the assistance information for the second aerospace platform, during a period of time the geographic area is served by the first NTN cell, before the geographic area is served by the second NTN cell.

Some example implementations provide an apparatus comprising: at least one memory configured to store computer-readable program code; and at least one processing circuitry configured to access the at least one memory, and execute the computer-readable program code to cause the apparatus to at least: receive scheduling information for system information blocks (SIBs) at a user equipment, the SIBs including information elements with assistance information for a first aerospace platform, and a separate at least one information element with assistance information for a second aerospace platform, the first aerospace platform and the second aerospace platform configured to provide respectively a first non-terrestrial network (NTN) cell and a second NTN cell that are quasi-Earth-fixed cells serving a geographic area for limited periods of time; and acquire the separate at least one information element with the assistance information for the second aerospace platform, at the user equipment in the first NTN cell, during a period of time the geographic area is served by the first NTN cell, before the geographic area is served by the second NTN cell.

Some example implementations provide an apparatus comprising: means for receiving scheduling information for system information blocks (SIBs) at an user equipment, the SIBs including information elements with assistance information for a first aerospace platform, and a separate at least one information element with assistance information for a second aerospace platform, the first aerospace platform and the second aerospace platform configured to provide respectively a first non-terrestrial network (NTN) cell and a second NTN cell that are quasi-Earth-fixed cells serving a geographic area for limited periods of time; and means for acquiring the separate at least one information element with the assistance information for the second aerospace platform, at the user equipment in the first NTN cell, during a period of time the geographic area is served by the first NTN cell, before the geographic area is served by the second NTN cell.

Some example implementations provide a method comprising: scheduling transmission of system information blocks (SIBs) including information elements with assistance information for a first aerospace platform, and a separate at least one information element with assistance information for a second aerospace platform, the first aerospace platform and the second aerospace platform configured to provide respectively a first non-terrestrial network (NTN) cell and a second NTN cell that are quasi-Earth-fixed cells serving a geographic area for limited periods of time; and causing a user equipment in the first NTN cell to acquire the separate at least one information element with the assistance information for the second aerospace platform, during a period of time the geographic area is served by the first NTN cell, before the geographic area is served by the second NTN cell.

Some example implementations provide a method comprising: receiving scheduling information for system information blocks (SIBs) at a user equipment, the SIBs including information elements with assistance information for a first aerospace platform, and a separate at least one information element with assistance information for a second aerospace platform, the first aerospace platform and the second aerospace platform configured to provide respectively a first non-terrestrial network (NTN) cell and a second NTN cell that are quasi-Earth-fixed cells serving a geographic area for limited periods of time; and acquiring the separate at least one information element with the assistance information for the second aerospace platform, at the user equipment in the first NTN cell, during a period of time the geographic area is served by the first NTN cell, before the geographic area is served by the second NTN cell.

Some example implementations provide a computer-readable storage medium that is non-transitory and has computer-readable program code stored therein that, in response to execution by at least one processing circuitry, causes an apparatus to at least:

schedule transmission of system information blocks (SIBs) including information elements with assistance information for a first aerospace platform, and a separate at least one information element with assistance information for a second aerospace platform, the first aerospace platform and the second aerospace platform configured to provide respectively a first non-terrestrial network (NTN) cell and a second NTN cell that are quasi-Earth-fixed cells serving a geographic area for limited periods of time; and cause a user equipment in the first NTN cell to acquire the separate at least one information element with the assistance information for the second aerospace platform, during a period of time the geographic area is served by the first NTN cell, before the geographic area is served by the second NTN cell.

Some example implementations provide a computer-readable storage medium that is non-transitory and has computer-readable program code stored therein that, in response to execution by at least one processing circuitry, causes an apparatus to at least: receive scheduling information for system information blocks (SIBs) at a user equipment, the SIBs including information elements with assistance information for a first aerospace platform, and a separate at least one information element with assistance information for a second aerospace platform, the first aerospace platform and the second aerospace platform configured to provide respectively a first non-terrestrial network (NTN) cell and a second NTN cell that are quasi-Earth-fixed cells serving a geographic area for limited periods of time; and acquire the separate at least one information element with the assistance information for the second aerospace platform, at the user equipment in the first NTN cell, during a period of time the geographic area is served by the first NTN cell, before the geographic area is served by the second NTN cell.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIG. 1 illustrates a telecommunications system that includes one or more public land mobile networks (PLMNs) coupled to one or more external data networks, according to some example implementations of the present disclosure;

FIG. 2 illustrates a 5G deployment of a PLMN, according to some example implementations;

FIG. 3 illustrates a deployment of a non-terrestrial networks (NTN) in the 5G deployment of FIG. 2, according to some example implementations;

FIG. 4 illustrates an example of satellite switching in an NTN, according to some example implementations;

FIG. 5 illustrates a timing diagram according to some example implementaions;

FIG. 6 is a flowchart illustrating various steps in a method, according to some example implementations;

FIGS. 7A, 7B, 7C, 7D and 7E are more descriptive flowcharts illustrating various steps in a method, from the perspective of a radio access node, according to various example implementations;

FIGS. 8A, 8B, 8C, 8D and 8E are more descriptive flowcharts illustrating various steps in a method, from the perspective of a user equipment, according to various example implementations; and

FIG. 9 illustrates an apparatus according to some example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably. The term “network” may refer to a group of interconnected computers including clients and servers; and within a network, these computers may be interconnected directly or indirectly by various means including via one or more switches, routers, gateways, access points or the like.

Reference may be made herein to terms specific to a particular system, architecture or the like, but it should be understood that example implementations of the present disclosure may be equally applicable to any of a number of systems, architectures and the like. For example, reference may be made to 3GPP technologies such as Global System for Mobile Communications (GSM), UMTS, LTE, LTE Advanced and 5G NR; however, it should be understood that example implementations of the present disclosure may be equally applicable to non-3GPP technologies such as IEEE 802, Bluetooth and Bluetooth Low Energy.

Further, as used in this application, the term “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions); or (c) hardware circuit(s) and/or processor(s), such as a microprocessor(s) or a portion of a microprocessor(s), that requires software (e.g., firmware) for operation, but the software may not be present when it is not needed for operation.

The above definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

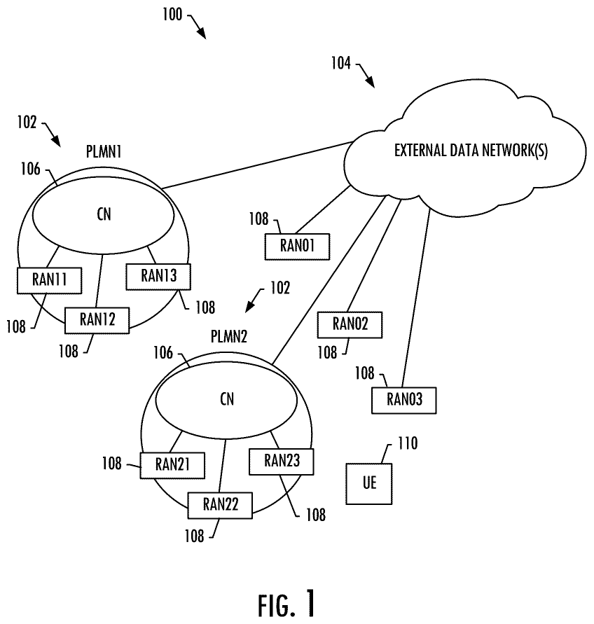

FIG. 1 illustrates a telecommunications system 100 according to various example implementations of the present disclosure. The telecommunications system generally includes one or more telecommunications networks. As shown, for example, the system includes one or more public land mobile networks (PLMNs) 102 coupled to one or more other external data networks 104—notably including a wide area network (WAN) such as the Internet. Each of the PLMNs includes a core network (CN) 106 backbone such as the Evolved Packet Core (EPC) of LTE, the 5G core network (5GC) or the like; and each of the core networks and the Internet are coupled to one or more radio access networks (RANs) 108, air interfaces or the like that implement one or more radio access technologies (RATs). As used herein, a “network device” refers to any suitable device at a network side of a telecommunications network. Examples of suitable network devices are described in greater detail below.

In addition, the system includes one or more radio units that may be varyingly known as user equipment (UE) 110, terminal device, terminal equipment, mobile station or the like. The UE is generally a device configured to communicate with a network device or a further UE in a telecommunication network. The UE may be a portable computer (e.g., laptop, notebook, tablet computer), mobile phone (e.g., cell phone, smartphone), wearable computer (e.g., smartwatch), or the like. In other examples, the UE may be an Internet of things (IoT) device, an industrial IoT (IIOT device), a vehicle equipped with a vehicle-to-everything (V2X) communication technology, or the like. In operation, these UEs may be configured to connect to one or more of the RANs 108 according to their particular radio access technologies to thereby access a particular core network of a PLMN 102, or to access one or more of the external data networks 104 (e.g., the Internet). The external data network may be configured to provide Internet access, operator services, 3rd party services, etc. For example, the International Telecommunication Union (ITU) has classified 5G mobile network services into three categories: enhanced mobile broadband (eMBB), ultra-reliable and low-latency communications (URLLC), and massive machine type communications (mMTC) or massive internet of things (MIoT).

Examples of radio access technologies include 3GPP radio access technologies such as GSM, UMTS, LTE, LTE Advanced, and 5G NR. Other examples of radio access technologies include IEEE 802 technologies such as IEEE 802.11 (Wi-Fi), IEEE 802.15 (including 802.15.1 (WPAN/Bluetooth), 802.15.4 (Zigbee) and 802.15.6 (WBAN)), Bluetooth, Bluetooth Low Energy (BLE), ultra wideband (UWB), and the like. Generally, a radio access technology may refer to any 2G, 3G, 4G, 5G or higher generation mobile communication technology and their different versions, as well as to any other wireless radio access technology that may be arranged to interwork with such a mobile communication technology to provide access to the core network of a mobile network operator (MNO).

In various example, a RAN 108 may be configured as one or more macrocells, microcells, picocells, femtocells or the like. The RAN may generally include one or more radio access nodes that are configured to interact with UEs 110. In various examples, a radio access node may be referred to as a base station (BS), access point (AP), base transceiver station (BTS), Node B (NB), evolved NB (eNB), macro BS, NB (MNB) or eNB (MeNB), home BS, NB (HNB) or eNB (HeNB), next generation NB (gNB), next generation eNB (ng-eNB), or the like. Some type of network controlling/governing entity responsible for control of the radio access nodes. The network controlling/governing entity and radio access node may be separate or integrated into a single apparatus. The network controlling/governing entity may include processing circuitry configured to carry out various management functions, etc. The processing circuitry may be associated with a computer-readable storage medium or database for maintaining information required in the management functions.

A RAN 108 may be centralized or distributed. In various examples, components of a RAN may be interconnected by Ethernet, Gigabit Ethernet, Asynchronous Transfer Mode (ATM), optical fiber, dark fiber, passive wavelength division multiplexing (WDM), WDM passive optical network (WDM-PON), optical transport network (OTN), time sensitive networking (TSN) and/or any other data link layer network, possibly including radio links. The RAN may be connected to a CN 106 through one or more gateways, network functions or the like.

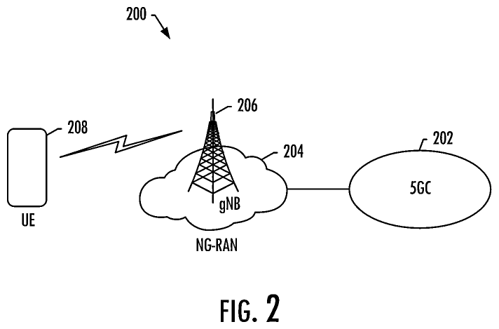

As will be appreciated, a PLMN 102 may be deployed in a number of different manners. In a 4G LTE deployment, the EPC is the CN 106, and the evolved UMTS terrestrial radio access network (E-UTRAN) is the RAN 108; and the E-UTRAN includes one or more eNBs (radio access nodes) configured connect UEs 110 to the E-UTRAN to thereby access the EPC. As shown in FIG. 2, in a 5G deployment 200, the 5GC 202 is the CN, and the next generation (NG) radio access network (NG-RAN) 204 is the RAN; and the NG-RAN includes one or more gNBs 206 (radio access nodes) configured connect UEs 208 to the NG-RAN to thereby access the 5GC. The term ‘gNB’ in 5G may correspond to the eNB in 4G LTE.

Some 4G LTE and 5G deployments are considered standalone (SA) deployments. Other deployments combine 4G LTE and 5G technologies, and are referred to as non-standalone (NSA) deployments. In some deployments, the E-UTRAN includes one or more ng-eNBs that are configured to communicate with the 5GC, and that may also be configured to communicate with one or more gNBs. Similarly, in another deployment, the NG-RAN may include one or more en-gNBs that are configured to communicate with the EPC, and that may also be configured to communicate with one or more eNBs.

In various instances, a single UE 110, 208 a dual-mode or multimode UE, may support multiple (two or more) RANs-thereby being configured to connect to multiple RANs. For example, a particular UE may support both LTE and 5G NR radio access technologies. In this regard, a number of deployments support dual connectivity (DC), and in some particular examples multi-radio dual connectivity (MR-DC), in which a UE may be configured to connect to two different radio access nodes connected via a non-ideal backhaul, one of the radio access nodes providing NR access and the other radio access node providing either E-UTRA or NR access.

In radio communications, node operations may in be carried out, at least partly, in a central/centralized unit (CU), such as a server, host or node, operationally coupled to a distributed unit (DU), such as a radio head/node. It is also possible that node operations may be distributed among a plurality of servers, hosts or nodes. It should also be understood that the distribution of work between CN 106 operations and radio access node (RAN 108) operations may vary depending on implementation. Thus, a 5G network architecture may be based on a so-called CU-DU split. One gNB-CU (central node) may control one or more gNB-DUs. The gNB-CU may control a plurality of spatially separated gNB-DUs, acting at least as transmit/receive (Tx/Rx) nodes. In some example implementations, however, the gNB-DUs (also called DU) may include, for example, a radio link control (RLC), medium access control (MAC) layer and a physical (PHY) layer, whereas the gNB-CU (also called a CU) may include the layers above the RLC layer, such as a packet data convergence protocol (PDCP) layer, a radio resource control (RRC), and an internet protocol (IP) layer. Other functional splits are also possible. It is considered that skilled person is familiar with the OSI model and the functionalities within each layer.

In some example implementations, the server or CU may generate a virtual network through which the server communicates with the radio node. In general, virtual networking may involve a process of combining hardware and software network resources and network functionality into a single, software-based administrative entity, a virtual network. Such virtual network may provide flexible distribution of operations between the server and the radio head/node. In practice, any digital signal processing task may be performed in either the CU or the DU, and the boundary where the responsibility is shifted between the CU and the DU may be selected according to implementation.

Networks including 5G are now starting to support non-terrestrial networks (NTNs). In an NTN system, radio access node (e.g., gNB) or radio access node functionality may be deployed onboard satellites or other aerospace platforms in a regenerative deployment (or architecture), or relayed by radio access nodes in a transparent deployment. The NTN may therefore provide communication coverage over a very large area that may be otherwise unreachable by a terrestrial radio access network alone. Such functionality can be used to globally connect IoT devices, as well as provide personal communication in remote areas and in disaster relief.

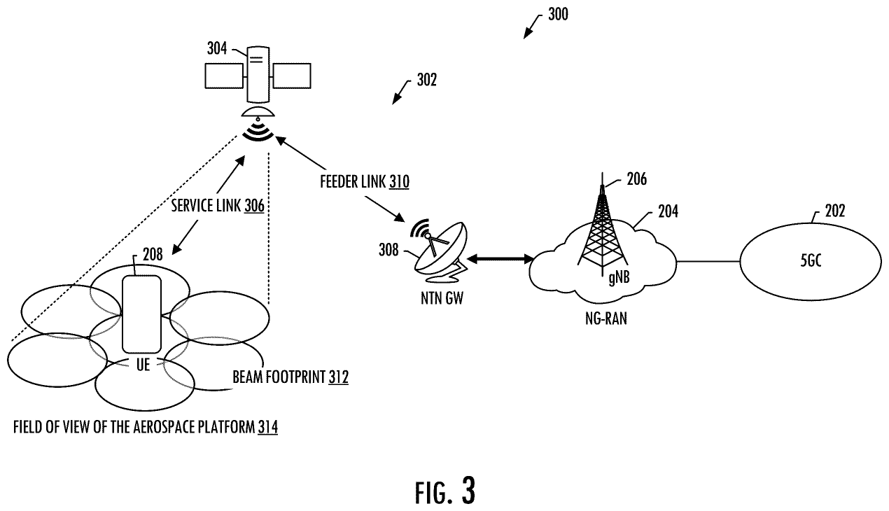

FIG. 3 illustrates a deployment 300 of an NTN 302 in the 5G deployment 200 of FIG. 2, according to some example implementations. As shown, the NTN may include an aerospace platform, such as a satellite 304, connected to a UE 208 by a service link 306 (radio link), and connected to an NTN gateway 308 by a feeder link 310 (radio link). The NTN gateway, then, may be connected to the gNB. In some examples, the NTN gateway and the gNB may be co-located.

In various examples, the aerospace platform may be a spaceborne or airborne platform, vehicle or the like. As indicated, the aerospace platform may be a satellite 304. In other more specific examples, the aerospace platform may be a low-earth orbit (LEO) satellite, medium-earth orbit (MEO) satellite, geostationary earth orbit (GEO) satellite, or the like. Likewise, in more specific examples, the aerospace platform may be an unmanned aircraft system (UAS), such as a tethered UAS (TUA), lighter than air UAS (LTA), heavier than air UAS (HTA), high altitude platforms (HAP), or the like. Some example implementations of the present disclosure may be described in the context of a satellite or UAS, but it should be understood that those example implementations are equally applicable to other aerospace platforms.

In particular examples in which aerospace platform is a satellite 304 of the NTN 302 in a transparent deployment, the satellite may implement a payload that is transparent. That is, the satellite may implement radio frequency (RF) filtering, conversion and amplification. Hence, the waveform signal repeated by the payload may be unchanged. The satellite may generate radio coverage beams with respective footprints 312 over a given service area bounded by its field of view 314 and onboard antenna technology. The respective footprints of the radio beams are typically of elliptic shape. The field of view of the satellite may depend on an onboard antenna diagram and/or minimum elevation angle. One radio beam may carry the signals of a NR cell, and several satellite radio beams may carry the signals of a single NR cell or multiple NR cells.

In an effort to reducing signaling overhead and simplifying RRC procedures for the UE 208, the topic of an unchanged physical cell identifier (PCI) has been introduced. The working principle is that after the UE switches from one satellite to another satellite, the serving gNB 206 (on ground) does not change; and therefore, much of the cell configuration may be kept without changing the PCI, frequency, and other cell configuration parameters. The satellite switching, then, may be almost transparent for the UE, which is not required to perform layer 3 (L3) mobility (i.e., handover procedure), or update its security key.

Some conditions for implementation of satellite switching without L3 mobility, with an unchanged PCI or a changed PCI, may include that NTN cells served by the satellites are deployed as quasi-Earth fixed cells (EFC) that serve a geographic area for limited periods of time. The network (e.g., gNB 206) may indicate to the UE 208 how/when to perform downlink and uplink synchronization with a new satellite after switching, or the network may accept an interruption gap for the UE to detect and adapt to the timing of the new satellite.

More recent focus has been on the transparent deployment (or architecture), including the case when the NTN cells are provided by the same gNB 206. That is, the same cell with the fixed PCI may be provided by the same gNB, so only the satellite is changed. But in other cases, satellite switching without L3 mobility may work with different gNBs, and potentially even for the regenerative deployment.

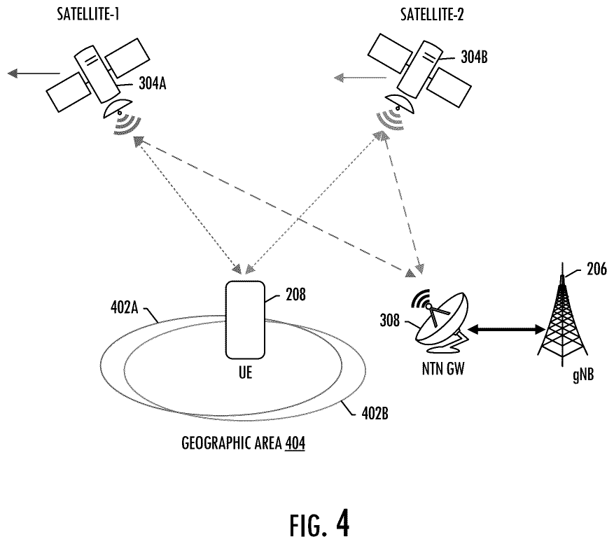

FIG. 4 illustrates an example of satellite switching without L3 mobility in an NTN, in a transparent deployment in which a first satellite 304A and a second satellite 304B provide respectively a first NTN cell 402A and a second NTN cell 402B that are quasi-Earth-fixed cells (EFCs) serving a geographic area 410. In this regard, the first NTN cell and the second NTN cell may be the same cell, at least for the limited periods of time the NTN cells serve the geographic area. Leading up to the satellite switching, the UE 208 may be stationary and served by the first NTN cell of the first satellite. As the first satellite moves away from the UE, and the second satellite approaches the UE, the network (e.g., gNB 206) may indicate to the UE when the satellite switching will occur and how to perform re-synchronization to the second NTN cell. The second satellite then takes over, and the UE performs downlink/uplink synchronization operations to reconnect.

In FIG. 4, even though the UE 208 is being served by the second satellite 304B, the UE may not change the serving gNB 206, so the UE may keep the cell configuration. The first satellite 304A and the second satellite may be configured with the same fixed PCI, same UE context, and same protocol stack, including synchronization signal (SS) block (SSB) generation, coding/decoding, modulation/demodulation, same control resource set (CORESET) configuration, switch routing and the like. But from the UE's reference, the first satellite and the second satellite may introduce different frequency (i.e., Doppler) and timing drifts.

Satellite switching can be broken down in two additional scenarios, namely, soft satellite switching and hard satellite switching. In this regard, soft satellite switching considers a certain overlap between the first NTN cell 402A and the second NTN cell 402B, while hard satellite switching considers no overlap between the cells (although the UE 208 may consider certain interruption time to pre-compensate frequency and timing of the second NTN cell). For soft satellite switching, it may be assumed that the first satellite 304A and the second satellite 304B transmit their SSBs at the same time, and potentially with the same PCI but different time/frequency offset), which may allow the UE to gracefully switch from the first satellite to the second satellite.

When the UE 208 enters the geographic area 410, the UE may perform a cell search and synchronization, during which the UE may acquire system information broadcast by the gNB 206 via the first satellite 304A that provides the first NTN cell 402A serving the geographic area. Different types of system information may be transmitted in system information blocks (SIBs). One block, for example, is known as the master information block (MIB). The system information other than the MIB may be referred to as the Remaining Minimum System Information (RMSI). One example RMSI, labeled as SIB type 1 (SIB1), includes information relating to access restriction information of the UE, and scheduling information for other SIBs.

The other SIBs include a SIB type 19 (SIB19) (SIB3/31/32 for IoT NTN) that includes information elements (IEs) with satellite assistance information for NTN access. This satellite assistance information may include, for example, configuration parameters for the UE to access the network via NTN access, such as Ephemeris data, common timing advance (TA) parameters, Koffset, validity duration for uplink sync information and epoch. The satellite assistance information may also include, for example, a list of NTN neighbor cells including their configuration parameters, a reference location of the serving cell provided by a satellite (e.g., first NTN cell 402A provided by the first satellite 304A). The satellite assistance information may further include a time at which the serving cell stops serving the geographic area it covers (e.g., geographic area 410), which may be provided in an IE referred to as t-service that indicates the period of time the serving cell serves the geographic area.

In the case of at least the hard satellite switching (i.e., no overlapping time between old and new cells), a very short interruption gap may be expected where the UE 208 will switch from the first satellite 304A to the second satellite 304B in as seamless a manner as possible. In order to make a seamless switch in which the UE detaches from the old cell and immediately starts uplink transmissions in the new cell, the UE may require assistance information of the second satellite 304B (including the satellite's Ephemeris data and common TA parameters) to pre-compensate frequency and timing drifts.

One option to provide assistance information of the second satellite 304B may be to use the neighbor cell's IE embedded in SIB19. But this option may have drawbacks in situations in which the first and second NTN cells 402A, 402B share a fixed PCI, such as in the case of a UE 208 that stores satellite assistance information per PCI. This option may also result in an overloaded SIB19, particularly given the UE will only require the neighbor cell's information close to expiration of t-service, when the second satellite approaches the geographic area 410. One of the purposes of an unchanged PCI is to reduce signaling overhead, and by re-using SIB19 in this manner, signaling may instead be increased.

Example implementations of the present disclosure provide a mechanism for satellite switching without L3 mobility (with an unchanged PCI or a changed PCI) in which a UE 208 may acquire a new satellite's assistance information in a timely manner, without overloading existing SIBs and without increasing signaling overhead. According to example implementations, the UE may acquire assistance information for the second satellite 304B in at least one information element other than the information elements provided with SIB19, such as in a separate SIB of another type (referred to herein as SIBxx), before t-service expires for the first satellite 304A, without increasing either the signaling overhead or the UE's power consumption. In some examples, SIBxx may include one or more IEs with only that system information related to satellite switching without L3 mobility, such as the satellite's Ephemeris data, common TA parameters, switching gap duration, supported random access (RA) procedure, time/frequency offset to search for the second NTN cell's SSBs, and the like.

As described in greater detail below, in some examples, the gNB 206 may schedule SIBxx with the other SIBs for which SIB1 provides scheduling information. These other SIBs may be periodically transmitted, such as via the satellite 304A, 304B providing the NTN cell 402A, 402B serving the geographic area 404. In various examples, however, SIBxx may or may not be transmitted with the other SIBs. Instead, a trigger event may be defined for transmission of SIBxx, or otherwise for the UE 208 to acquire SIBxx. The trigger event may be defined to occur during the period of time the geographic area 404 is served by the first NTN cell 402A provided by the first satellite 304A (during t-service of the first satellite), such as during a last number K of modification periods before expiration of t-service.

The UE 208 may be exempt from acquiring SIBxx at least until the trigger event is detected, and before t-service of the first satellite 304A expires. The UE may then acquire SIBxx, and apply the assistance information for the second satellite 304B to synchronize with the second satellite, and switch from the first NTN cell 402A provided by the first satellite, to the second NTN cell 402B. In some examples, however, a UE in an idle mode may skip acquisition of SIBxx, as long as the UE does not perform a random access channel (RACH) procedure until a time T after t-service of the first satellite expires. As the UE may acquire SIB1 only one time, the UE may foresee the presence of SIBxx at a future point in time, but only acquire SIBxx when/if needed, which may significantly reduce UE power consumption on SIB monitoring.

Some example implementations therefore provide a radio access node configured to schedule transmission of SIBs including IEs with assistance information for a first aerospace platform, and a separate information element with assistance information for a second aerospace platform. In some examples described below, the radio access node may correspond to the gNB 206, and the first aerospace platform and the second aerospace platform may correspond to respectively the first satellite 304A and the second satellite 304B. As described above, the first satellite and the second satellite may be configured to provide respectively a first NTN cell 402A and a second NTN cell 402B that are EFCs serving a geographic area 404 for limited periods of time. In some examples, the first satellite and the second satellite may share a fixed PCI.

The gNB 206 also be configured to cause a UE 208 in the first NTN cell 402A to acquire the separate IE(s) with the assistance information for the second satellite 304B, during a period of time the geographic area is served by the first NTN cell (t-service), before the geographic area is served by the second NTN cell 402B. In some more particular examples, the SIBs include a SIB of one type (e.g., SIB19) that includes the IEs with the assistance information for the first satellite 304A, and a separate SIB of another type (e.g., SIBxx) that includes the separate IE(s) with the assistance information for the second satellite 304B. And in some of these examples, the gNB may cause the UE 208 to acquire the separate SIB that includes the separate IE(s). The UE may then apply the assistance information for the second satellite, from the IE(s), to switch the UE from the first NTN cell provided by the first satellite, to the second NTN cell provided by the second satellite. In this regard, the UE may acquire the assistance information for the second satellite before t-service of the first satellite expires, and applies the assistance information before/during any interruption gap to re-synchronize to the second NTN cell.

In some more particular examples, the gNB 206 may broadcast the separate IE(s) (e.g., in SIBxx), via the first satellite 304A, for the UE 208 to acquire on or after a trigger event during the period of time the geographic area is served by the first NTN cell 402A. In some examples, the trigger event may be marked by a last number of modification periods before a time at which the first NTN cell stops serving the geographic area. The time at which the first NTN cell stops serving the geographic area may be indicated in the IEs (e.g., in SIB19) with the assistance information for the first satellite. Similarly, the number of modification periods may be indicated in the IEs with the assistance information for the first satellite. In this regard, a parameter K that indicates the number of modification periods may be provided to the UE as an explicit flag to instruct the UE to use the mechanism for satellite switching without L3 mobility. In particular, for example, if K is not null, the UE may conduct NTN cell switch without L3 mobility; else, the UE may expect an RRC reconfiguration message before t-service.

In some examples, the gNB 206 may be configured to detect the trigger event, and broadcast the separate IE(s) (e.g., in SIBxx) only on or after the trigger event is detected. In other examples, the gNB may broadcast the separate IE(s) before and after the trigger event is detected, with the UE 208 being exempt from acquiring the separate IE(s) at least until the trigger event is detected at the UE. In some of these other examples, the trigger event may be detected by the UE. In these and similar examples in which the trigger event is marked by the last number of modification periods, the gNB may transmit a paging message to the UE to cause the UE to acquire the separate IE(s) during one of the last number of modification periods, such as in a modification information procedure.

Example implementations of the present disclosure described above from the perspective of the gNB 206 (radio access node) apply equally to the UE 208. In this regard, information or messages that are from the perspective of the gNB, transmitted to or received from the UE, may instead be from the perspective of the UE, received from or transmitted to the gNB.

Example implementations of the present disclosure therefore also provide a UE 208 configured to receive (from the gNB 206 via the first satellite 304A) scheduling information for the SIBs, including the IEs (e.g., in SIB19) with assistance information for the first satellite, and the separate IE(s) (e.g., in SIBxx) with assistance information for the second satellite 304B. The UE, in the first NTN cell 402A, may acquire the separate IE(s) with the assistance information for the second satellite, during the period of time the geographic area is served by the first NTN cell, before the geographic area 404 is served by the second NTN cell. The UE may then apply the assistance information for the second satellite to switch the UE from the first NTN cell provided by the first satellite, to the second NTN cell 402B provided by the second satellite.

As described above, the gNB 206 of the network may include assistance information for the second satellite 304B in separate IE(s) (e.g., in SIBxx) from the IEs (e.g., in SIB19) with assistance information for the first satellite 304A. In this regard, the IE(s) with assistance information for the second satellite may be transparent to the IE(s) with assistance information for the first satellite, and may also alleviate load in SIB19 that may include those IEs. Scheduling information for the separate IE(s) may be provided, but effectively not used (saving resources on the physical layer) until strictly needed (close to the satellite switching). This may allow the UE to considerably minimize the acquisition of resources of the second satellite.

FIG. 5 illustrates a timing diagram 500 according to some example implementations. As shown, the first two scheduled transmissions 502 of SIBxx are not executed, as these scheduled transmissions are before the trigger event, which is before the satellite switching time 504. But on the third scheduled transmission 506, on or after the trigger event (before the satellite switching time), the network transmits SIBxx with the assistance information for the second satellite 304B. Also shown are SIBs 508 transmitted via the second satellite after satellite switching, and these SIBs may include an SIB19 with assistance information for the second satellite. Not shown are the SIBs transmitted via the first satellite prior to the scheduled transmissions/transmission of SIBxx. These SIBs, however, may include a validity time that extends into the satellite switching so that the UE may still be able to connect to the first satellite (current serving satellite before satellite switching).

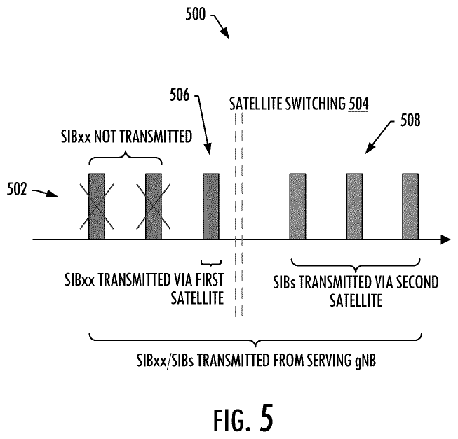

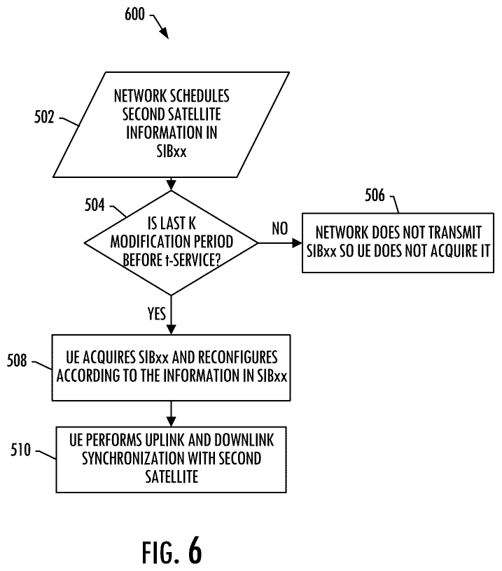

FIG. 6 is a flowchart illustrating various steps in a method 600, according to some example implementations. The method may include the network (e.g., gNB 206) scheduling SIBs, as shown at block 502. The network may monitor a time remaining with respect to t-service of the first satellite 304A, and not transmit SIBxx with assistance information for the second satellite 304B until the last K modification period before t-service, as shown at blocks 504 and 506. When the network detects that the number of remaining modification periods is equal to or less than K, the network may broadcast or otherwise transmit SIBxx for the UE to acquire, as shown at block 508. The UE may then apply the assistance information for the second satellite, which may include reading and using parameters (e.g., Ephemeris data, TA parameters and/or Koffset) for the second satellite, as shown at block 510. When the UE pre-compensates frequency and time drifts, and knows how to communicate with the second satellite, the UE may re-synchronize downlink and uplink streams so the connection with the gNB 206 continues. The UE does not need to repeatedly re-acquire all of the SIBs, and the network does not need to page all UEs with the modification information procedure, which may save signalling load the UE's power consumption.

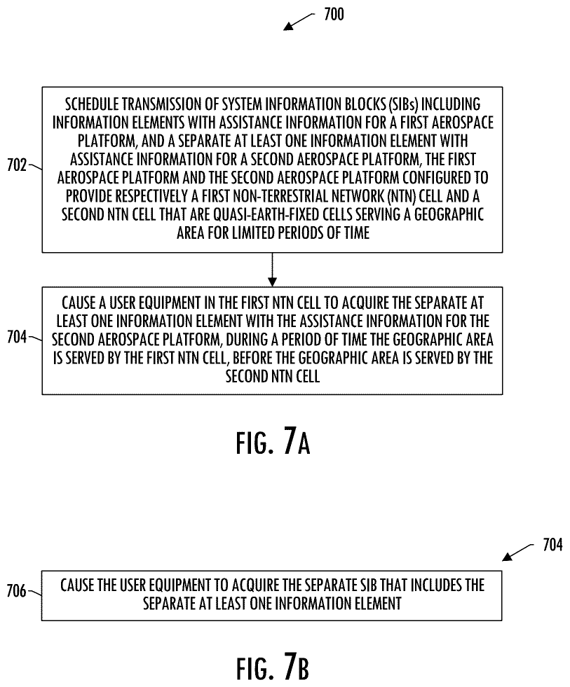

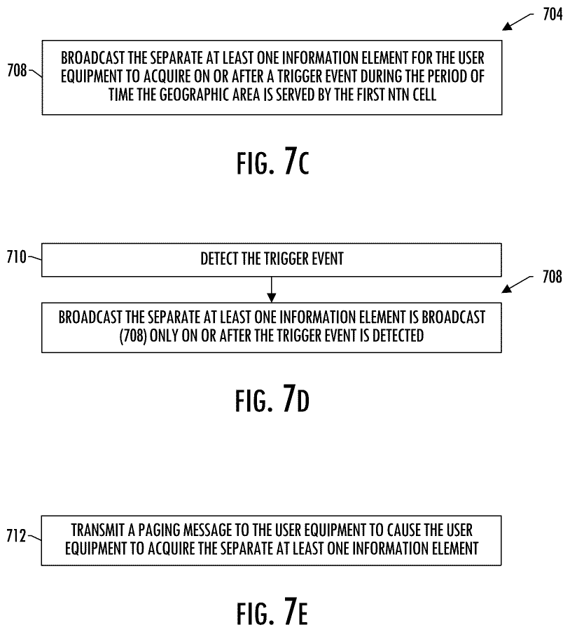

FIGS. 7A-7E are more descriptive flowcharts illustrating various steps in a method 700, from the perspective of a radio access node (e.g., gNB 206), according to various example implementations. The method includes scheduling transmission of system information blocks (SIBs) including information elements with assistance information for a first aerospace platform, and a separate at least one information element with assistance information for a second aerospace platform, as shown at block 702 of FIG. 7A. The first aerospace platform and the second aerospace platform are configured to provide respectively a first non-terrestrial network (NTN) cell and a second NTN cell that are quasi-Earth-fixed cells serving a geographic area for limited periods of time. The method also includes causing a user equipment in the first NTN cell to acquire the separate at least one information element with the assistance information for the second aerospace platform, during a period of time the geographic area is served by the first NTN cell, before the geographic area is served by the second NTN cell, as shown at block 704.

In some examples, the SIBs include a SIB of one type that includes the information elements with the assistance information for the first aerospace platform, and a separate SIB of another type that includes the separate at least one information element with the assistance information for the second aerospace platform. In some of these examples, causing the user equipment to acquire the separate at least one information element at block 704 includes causing the user equipment to acquire the separate SIB that includes the separate at least one information element, as shown at block 706 of FIG. 7B.

In some examples, causing the user equipment to acquire the separate at least one information element at block 704 includes broadcasting the separate at least one information element for the user equipment to acquire on or after a trigger event during the period of time the geographic area is served by the first NTN cell, as shown at block 708 of FIG. 7C. In some of these examples, the method 700 further includes detecting the trigger even, as shown at block 710 of FIG. 7D. The separate at least one information element is then broadcast at block 708 only on or after the trigger event is detected. In others of these examples, the separate at least one information element is broadcast at block 708 before and after the trigger event is detected, and the user equipment is exempt from acquiring the separate at least one information element at least until the trigger event is detected at the user equipment.

In some examples, the method 700 further includes transmitting a paging message to the user equipment to cause at block 704 the user equipment to acquire the separate at least one information element, as shown at block 712 of FIG. 7E.

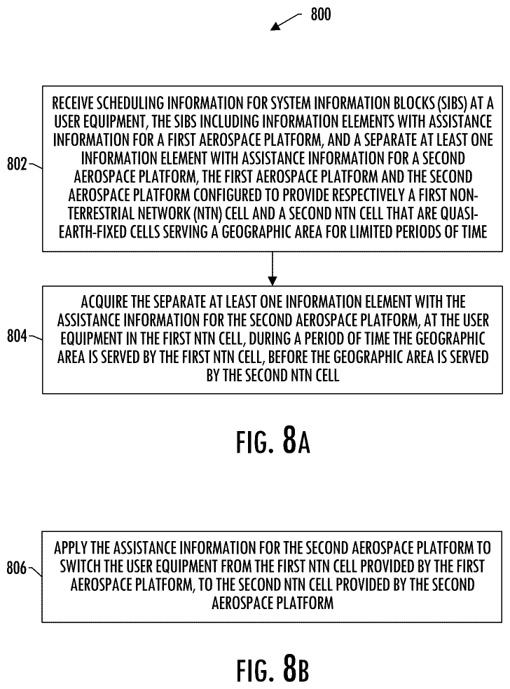

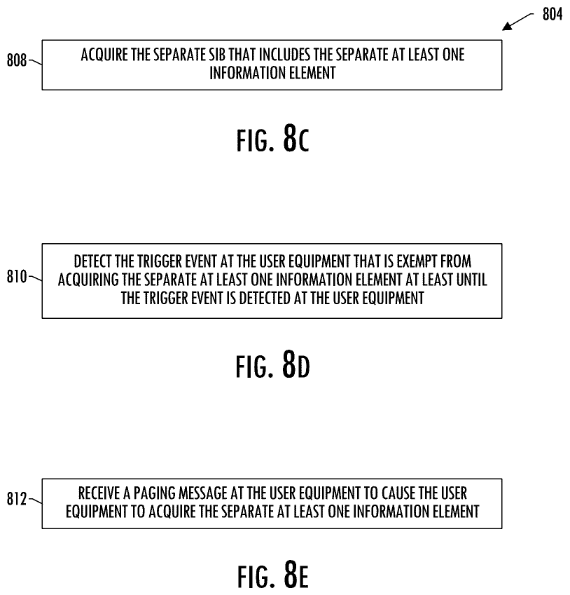

FIGS. 8A-8E are more descriptive flowcharts illustrating various steps in a method 800, from the perspective of a UE 208, according to various example implementations. The method includes receiving scheduling information for system information blocks (SIBs) at a user equipment, as shown at block 802 of FIG. 8A. The SIBs including information elements with assistance information for a first aerospace platform, and a separate at least one information element with assistance information for a second aerospace platform, the first aerospace platform and the second aerospace platform configured to provide respectively a first non-terrestrial network (NTN) cell and a second NTN cell that are quasi-Earth-fixed cells serving a geographic area for limited periods of time. The method also includes acquiring the separate at least one information element with the assistance information for the second aerospace platform, at the user equipment in the first NTN cell, during a period of time the geographic area is served by the first NTN cell, before the geographic area is served by the second NTN cell, as shown at block 804.

In some examples, the method 800 further includes applying the assistance information for the second aerospace platform to switch the user equipment from the first NTN cell provided by the first aerospace platform, to the second NTN cell provided by the second aerospace platform, as shown at block 806 of FIG. 8B.

In some examples, the SIBs include a SIB of one type that includes the information elements with the assistance information for the first aerospace platform, and a separate SIB of another type that includes the separate at least one information element with the assistance information for the second aerospace platform. In some of these examples, acquiring the separate at least one information element at block 804 includes acquiring the separate SIB that includes the separate at least one information element, as shown at block 808 of FIG. 8C.

In some examples, the separate at least one information element is broadcast before and after the trigger event is detected. The method 800 further includes detecting the trigger event at the user equipment that is exempt from acquiring the separate at least one information element at least until the trigger event is detected at the user equipment, as shown at block 810 of FIG. 8D.

In some examples, the method 800 further includes receiving a paging message at the user equipment to cause the user equipment to acquire at block 804 the separate at least one information element, as shown at block 812 of FIG. 8E.

According to example implementations of the present disclosure, a telecommunications system 100 or PLMN 102, and its components such as a UE 208, radio access node (e.g., gNB 206), aerospace platform (e.g., satellite 304, 304A, 304B) and/or NTN gateway 308, may be implemented by various means. Means for implementing the system and its components may include hardware, alone or under direction of one or more computer programs from a computer-readable storage medium, such as computer memory (or more simply “memory”). In some examples, one or more apparatuses may be configured to function as or otherwise implement the system and its components shown and described herein. In examples involving more than one apparatus, the respective apparatuses may be connected to or otherwise in communication with one another in a number of different manners, such as directly or indirectly via a wired or wireless network or the like.

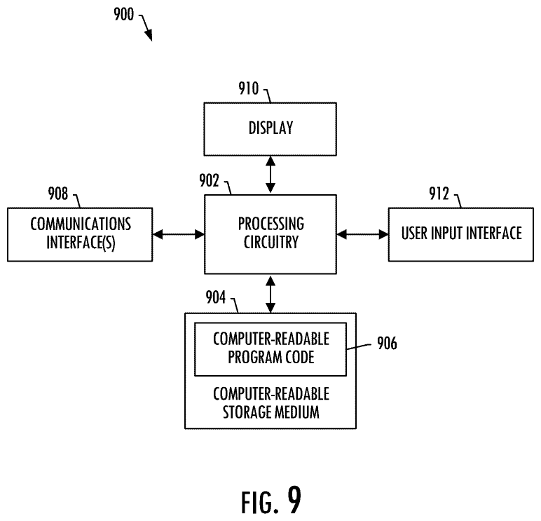

FIG. 9 illustrates an apparatus 900 according to some example implementations of the present disclosure. Generally, an apparatus of exemplary implementations of the present disclosure may comprise, include or be embodied in one or more fixed or portable electronic devices. Examples of suitable electronic devices include a wearable computer, mobile phone, portable computer, desktop computer, workstation computer, server (server computer) or the like. The apparatus may include one or more of each of a number of components such as, for example, processing circuitry 902 connected to computer-readable storage medium 904.

The processing circuitry 902 may be composed of one or more processors alone or in combination with one or more computer-readable storage media. The processing circuitry is generally any piece of computer hardware that is capable of processing information such as, for example, data, computer programs and/or other suitable electronic information. The processing circuitry is composed of a collection of electronic circuits some of which may be packaged as an integrated circuit or multiple interconnected integrated circuits (an integrated circuit at times more commonly referred to as a “chip”). The processing circuitry may be configured to execute computer programs, which may be stored onboard the processing circuitry or otherwise stored in the computer-readable storage medium 904 (of the same or another apparatus).

The processing circuitry 902 may be a number of processors, a multi-core processor or some other type of processor, depending on the particular implementation. Further, the processing circuitry may be implemented using a number of heterogeneous processor systems in which a main processor is present with one or more secondary processors on a single chip. As another illustrative example, the processing circuitry may be a symmetric multi-processor system containing multiple processors of the same type. In yet another example, the processing circuitry may be embodied as or otherwise include one or more ASICs, FPGAs or the like. Thus, although the processing circuitry may be capable of executing a computer program to perform one or more functions, the processing circuitry of various examples may be capable of performing one or more functions without the aid of a computer program. In either instance, the processing circuitry may be appropriately programmed to perform functions or operations according to example implementations of the present disclosure.

The computer-readable storage medium 904 is generally any piece of computer hardware that is capable of storing information such as, for example, data, computer programs (e.g., computer-readable program code 906) and/or other suitable information either on a temporary basis and/or a permanent basis. The computer-readable storage medium may include volatile and/or non-volatile memory, and may be fixed or removable. Examples of suitable memory include random access memory (RAM), read-only memory (ROM), a hard drive, a flash memory, a thumb drive, a removable computer diskette, an optical disk or some combination of the above. The computer-readable storage medium is a non-transitory device capable of storing information, and is distinguishable from computer-readable transmission media such as electronic transitory signals capable of carrying information from one location to another. The term “non-transitory,” as used herein, is a limitation of the medium itself (i.e., tangible, not a signal) as opposed to a limitation on data storage persistency (e.g., RAM versus ROM). Computer-readable medium as described herein may generally refer to a computer-readable storage medium or computer-readable transmission medium.

In addition to the computer-readable storage medium 904, the processing circuitry 902 may also be connected to one or more interfaces for displaying, transmitting and/or receiving information. The interfaces may include a communications interface 908 and/or one or more user interfaces. The communications interface may be configured to transmit and/or receive information, such as to and/or from other apparatus(es), network(s) or the like. The communications interface may be configured to transmit and/or receive information by physical (wired) and/or wireless communications links. Examples of suitable communication interfaces include a network interface controller (NIC), wireless NIC (WNIC) or the like.

The user interfaces may include a display 910 and/or one or more user input interfaces 912. The display may be configured to present or otherwise display information to a user, suitable examples of which include a liquid crystal display (LCD), light-emitting diode (LED) display, organic LED (OLED) display, active-matrix OLED (AMOLED) or the like. The user input interfaces may be wired or wireless, and may be configured to receive information from a user into the apparatus, such as for processing, storage and/or display. Suitable examples of user input interfaces include a microphone, image or video capture device, keyboard or keypad, joystick, touch-sensitive surface (separate from or integrated into a touchscreen), biometric sensor or the like. The user interfaces may further include one or more interfaces for communicating with peripherals such as printers, scanners or the like.

As indicated above, program code instructions may be stored in a computer-readable storage medium, and executed by processing circuitry that is thereby programmed, to implement functions of the systems, subsystems, tools and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, a processing circuitry or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processing circuitry or other programmable apparatus to configure the computer, processing circuitry or other programmable apparatus to execute operations to be performed on or by the computer, processing circuitry or other programmable apparatus.

Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

Execution of instructions by a processing circuitry, or storage of instructions in a computer-readable storage medium, supports combinations of operations for performing the specified functions. In this manner, an apparatus 900 may include a processing circuitry 902 and a computer-readable storage medium 904 coupled to the processing circuitry, where the processing circuitry is configured to execute computer-readable program code 906 stored in the computer-readable storage medium. It will also be understood that one or more functions, and combinations of functions, may be implemented by special purpose hardware-based computer systems and/or processing circuitry which perform the specified functions, or combinations of special purpose hardware and program code instructions.

As explained above and reiterated below, the present disclosure includes, without limitation, the following example implementations.

Clause 1. An apparatus comprising: at least one memory configured to store computer-readable program code; and at least one processing circuitry configured to access the at least one memory, and execute the computer-readable program code to cause the apparatus to at least: schedule transmission of system information blocks (SIBs) including information elements with assistance information for a first aerospace platform, and a separate at least one information element with assistance information for a second aerospace platform, the first aerospace platform and the second aerospace platform configured to provide respectively a first non-terrestrial network (NTN) cell and a second NTN cell that are quasi-Earth-fixed cells serving a geographic area for limited periods of time; and cause a user equipment in the first NTN cell to acquire the separate at least one information element with the assistance information for the second aerospace platform, during a period of time the geographic area is served by the first NTN cell, before the geographic area is served by the second NTN cell.

Clause 2. The apparatus of clause 1, wherein the SIBs include a SIB of one type that includes the information elements with the assistance information for the first aerospace platform, and a separate SIB of another type that includes the separate at least one information element with the assistance information for the second aerospace platform, and wherein causing the user equipment to acquire the separate at least one information element includes causing the user equipment to acquire the separate SIB that includes the separate at least one information element.

Clause 3. The apparatus of clause 1 or clause 2, wherein causing the user equipment to acquire the separate at least one information element includes broadcasting the separate at least one information element for the user equipment to acquire on or after a trigger event during the period of time the geographic area is served by the first NTN cell.

Clause 4. The apparatus of clause 3, wherein the at least one processing circuitry is configured to execute the computer-readable program code to cause the apparatus to further detect the trigger event, and the separate at least one information element is broadcast only on or after the trigger event is detected.

Clause 5. The apparatus of clause 3 or clause 4, wherein the separate at least one information element is broadcast before and after the trigger event is detected, and the user equipment is exempt from acquiring the separate at least one information element at least until the trigger event is detected at the user equipment.

Clause 6. The apparatus of any of clauses 1 to 5, wherein the trigger event is marked by a last number of modification periods before a time at which the first NTN cell stops serving the geographic area.

Clause 7. The apparatus of clause 6, wherein the time at which the first NTN cell stops serving the geographic area is indicated in the information elements with the assistance information for the first aerospace platform.

Clause 8. The apparatus of clause 6 or clause 7, wherein the last number of modification periods is indicated in the information elements with the assistance information for the first aerospace platform.

Clause 9. The apparatus of any of clauses 1 to 8, wherein the at least one processing circuitry is configured to execute the computer-readable program code to cause the apparatus to further transmit a paging message to the user equipment to cause the user equipment to acquire the separate at least one information element.

Clause 10. An apparatus comprising: means for scheduling transmission of system information blocks (SIBs) including information elements with assistance information for a first aerospace platform, and a separate at least one information element with assistance information for a second aerospace platform, the first aerospace platform and the second aerospace platform configured to provide respectively a first non-terrestrial network (NTN) cell and a second NTN cell that are quasi-Earth-fixed cells serving a geographic area for limited periods of time; and means for causing an user equipment in the first NTN cell to acquire the separate at least one information element with the assistance information for the second aerospace platform, during a period of time the geographic area is served by the first NTN cell, before the geographic area is served by the second NTN cell.

Clause 11. The apparatus of clause 10, wherein the SIBs include a SIB of one type that includes the information elements with the assistance information for the first aerospace platform, and a separate SIB of another type that includes the separate at least one information element with the assistance information for the second aerospace platform, and wherein causing the user equipment to acquire the separate at least one information element includes means for causing the user equipment to acquire the separate SIB that includes the separate at least one information element.

Clause 12. The apparatus of clause 10 or clause 11, wherein causing the user equipment to acquire the separate at least one information element includes means for broadcasting the separate at least one information element for the user equipment to acquire on or after a trigger event during the period of time the geographic area is served by the first NTN cell.

Clause 13. The apparatus of clause 12, wherein the apparatus further comprises means for detecting the trigger event, and the separate at least one information element is broadcast only on or after the trigger event is detected.

Clause 14. The apparatus of clause 12 or clause 13, wherein the separate at least one information element is broadcast before and after the trigger event is detected, and the user equipment is exempt from acquiring the separate at least one information element at least until the trigger event is detected at the user equipment.

Clause 15. The apparatus of any of clauses 10 to 14, wherein the trigger event is marked by a last number of modification periods before a time at which the first NTN cell stops serving the geographic area.

Clause 16. The apparatus of clause 15, wherein the time at which the first NTN cell stops serving the geographic area is indicated in the information elements with the assistance information for the first aerospace platform.

Clause 17. The apparatus of clause 15 or clause 16, wherein the last number of modification periods is indicated in the information elements with the assistance information for the first aerospace platform.

Clause 18. The apparatus of any of clauses 10 to 17, wherein the apparatus further comprises means for transmitting a paging message to the user equipment to cause the user equipment to acquire the separate at least one information element.

Clause 19. An apparatus comprising: at least one memory configured to store computer-readable program code; and at least one processing circuitry configured to access the at least one memory, and execute the computer-readable program code to cause the apparatus to at least: receive scheduling information for system information blocks (SIBs) at a user equipment, the SIBs including information elements with assistance information for a first aerospace platform, and a separate at least one information element with assistance information for a second aerospace platform, the first aerospace platform and the second aerospace platform configured to provide respectively a first non-terrestrial network (NTN) cell and a second NTN cell that are quasi-Earth-fixed cells serving a geographic area for limited periods of time; and acquire the separate at least one information element with the assistance information for the second aerospace platform, at the user equipment in the first NTN cell, during a period of time the geographic area is served by the first NTN cell, before the geographic area is served by the second NTN cell.

Clause 20. The apparatus of clause 19, wherein the at least one processing circuitry is configured to execute the computer-readable program code to cause the apparatus to further apply the assistance information for the second aerospace platform to switch the user equipment from the first NTN cell provided by the first aerospace platform, to the second NTN cell provided by the second aerospace platform.

Clause 21. The apparatus of clause 19 or clause 20, wherein the SIBs include a SIB of one type that includes the information elements with the assistance information for the first aerospace platform, and a separate SIB of another type that includes the separate at least one information element with the assistance information for the second aerospace platform, and wherein acquiring the separate at least one information element includes the apparatus caused to acquire the separate SIB that includes the apparatus caused to the separate at least one information element.

Clause 22. The apparatus of any of clauses 19 to 21, wherein the at least one information element is broadcast for the user equipment to acquire on or after a trigger event during the period of time the geographic area is served by the first NTN cell.

Clause 23. The apparatus of clause 22, wherein the separate at least one information element is broadcast only on or after the trigger event is detected.

Clause 24. The apparatus of clause 22 or clause 23, wherein the separate at least one information element is broadcast before and after the trigger event is detected, and the at least one processing circuitry is configured to execute the computer-readable program code to cause the apparatus to further detect the trigger event at the user equipment that is exempt from acquiring the separate at least one information element at least until the trigger event is detected at the user equipment.

Clause 25. The apparatus of any of clauses 19 to 24, wherein the trigger event is marked by a last number of modification periods before a time at which the first NTN cell stops serving the geographic area.

Clause 26. The apparatus of clause 25, wherein the time at which the first NTN cell stops serving the geographic area is indicated in the information elements with the assistance information for the first aerospace platform.

Clause 27. The apparatus of clause 25 or clause 26, wherein the last number of modification periods is indicated in the information elements with the assistance information for the first aerospace platform.

Clause 28. The apparatus of any of clauses 19 to 27, wherein the at least one processing circuitry is configured to execute the computer-readable program code to cause the apparatus to further receive a paging message at the user equipment to cause the user equipment to acquire the separate at least one information element.

Clause 29. An apparatus comprising: means for receiving scheduling information for system information blocks (SIBs) at an user equipment, the SIBs including information elements with assistance information for a first aerospace platform, and a separate at least one information element with assistance information for a second aerospace platform, the first aerospace platform and the second aerospace platform configured to provide respectively a first non-terrestrial network (NTN) cell and a second NTN cell that are quasi-Earth-fixed cells serving a geographic area for limited periods of time; and means for acquiring the separate at least one information element with the assistance information for the second aerospace platform, at the user equipment in the first NTN cell, during a period of time the geographic area is served by the first NTN cell, before the geographic area is served by the second NTN cell.

Clause 30. The apparatus of clause 29, wherein the apparatus further comprises means for applying the assistance information for the second aerospace platform to switch the user equipment from the first NTN cell provided by the first aerospace platform, to the second NTN cell provided by the second aerospace platform.

Clause 31. The apparatus of clause 29 or clause 30, wherein the SIBs include a SIB of one type that includes the information elements with the assistance information for the first aerospace platform, and a separate SIB of another type that includes the separate at least one information element with the assistance information for the second aerospace platform, and wherein acquiring the separate at least one information element includes means for acquiring the separate SIB that includes the separate at least one information element.

Clause 32. The apparatus of any of clauses 29 to 31, wherein the at least one information element is broadcast for the user equipment to acquire on or after a trigger event during the period of time the geographic area is served by the first NTN cell.

Clause 33. The apparatus of clause 32, wherein the separate at least one information element is broadcast only on or after the trigger event is detected.

Clause 34. The apparatus of clause 32 or clause 33, wherein the separate at least one information element is broadcast before and after the trigger event is detected, and the apparatus further comprises means for detecting the trigger event at the user equipment that is exempt from acquiring the separate at least one information element at least until the trigger event is detected at the user equipment.

Clause 35. The apparatus of any of clauses 29 to 34, wherein the trigger event is marked by a last number of modification periods before a time at which the first NTN cell stops serving the geographic area.

Clause 36. The apparatus of clause 35, wherein the time at which the first NTN cell stops serving the geographic area is indicated in the information elements with the assistance information for the first aerospace platform.

Clause 37. The apparatus of clause 35 or clause 36, wherein the last number of modification periods is indicated in the information elements with the assistance information for the first aerospace platform.

Clause 38. The apparatus of any of clauses 29 to 37, wherein the apparatus further comprises second means for receiving a paging message at the user equipment to cause the user equipment to acquire the separate at least one information element.

Clause 39. A method comprising: scheduling transmission of system information blocks (SIBs) including information elements with assistance information for a first aerospace platform, and a separate at least one information element with assistance information for a second aerospace platform, the first aerospace platform and the second aerospace platform configured to provide respectively a first non-terrestrial network (NTN) cell and a second NTN cell that are quasi-Earth-fixed cells serving a geographic area for limited periods of time; and causing a user equipment in the first NTN cell to acquire the separate at least one information element with the assistance information for the second aerospace platform, during a period of time the geographic area is served by the first NTN cell, before the geographic area is served by the second NTN cell.

Clause 40. The method of clause 39, wherein the SIBs include a SIB of one type that includes the information elements with the assistance information for the first aerospace platform, and a separate SIB of another type that includes the separate at least one information element with the assistance information for the second aerospace platform, and wherein causing the user equipment to acquire the separate at least one information element includes causing the user equipment to acquire the separate SIB that includes the separate at least one information element.

Clause 41. The method of clause 39 or clause 40, wherein causing the user equipment to acquire the separate at least one information element includes broadcasting the separate at least one information element for the user equipment to acquire on or after a trigger event during the period of time the geographic area is served by the first NTN cell.

Clause 42. The method of clause 41, wherein the method further comprises detecting the trigger event, and the separate at least one information element is broadcast only on or after the trigger event is detected.

Clause 43. The method of clause 41 or clause 42, wherein the separate at least one information element is broadcast before and after the trigger event is detected, and the user equipment is exempt from acquiring the separate at least one information element at least until the trigger event is detected at the user equipment.

Clause 44. The method of any of clauses 39 to 43, wherein the trigger event is marked by a last number of modification periods before a time at which the first NTN cell stops serving the geographic area.

Clause 45. The method of clause 44, wherein the time at which the first NTN cell stops serving the geographic area is indicated in the information elements with the assistance information for the first aerospace platform.

Clause 46. The method of clause 44 or clause 45, wherein the last number of modification periods is indicated in the information elements with the assistance information for the first aerospace platform.

Clause 47. The method of any of clauses 39 to 46, wherein the method further comprises transmitting a paging message to the user equipment to cause the user equipment to acquire the separate at least one information element.

Clause 48. A method comprising: receiving scheduling information for system information blocks (SIBs) at a user equipment, the SIBs including information elements with assistance information for a first aerospace platform, and a separate at least one information element with assistance information for a second aerospace platform, the first aerospace platform and the second aerospace platform configured to provide respectively a first non-terrestrial network (NTN) cell and a second NTN cell that are quasi-Earth-fixed cells serving a geographic area for limited periods of time; and acquiring the separate at least one information element with the assistance information for the second aerospace platform, at the user equipment in the first NTN cell, during a period of time the geographic area is served by the first NTN cell, before the geographic area is served by the second NTN cell.

Clause 49. The method of clause 48, wherein the method further comprises applying the assistance information for the second aerospace platform to switch the user equipment from the first NTN cell provided by the first aerospace platform, to the second NTN cell provided by the second aerospace platform.

Clause 50. The method of clause 48 or clause 49, wherein the SIBs include a SIB of one type that includes the information elements with the assistance information for the first aerospace platform, and a separate SIB of another type that includes the separate at least one information element with the assistance information for the second aerospace platform, and wherein acquiring the separate at least one information element includes acquiring the separate SIB that includes the separate at least one information element.

Clause 51. The method of any of clauses 48 to 50, wherein the at least one information element is broadcast for the user equipment to acquire on or after a trigger event during the period of time the geographic area is served by the first NTN cell.

Clause 52. The method of clause 51, wherein the separate at least one information element is broadcast only on or after the trigger event is detected.

Clause 53. The method of clause 51 or clause 52, wherein the separate at least one information element is broadcast before and after the trigger event is detected, and the method further comprises detecting the trigger event at the user equipment that is exempt from acquiring the separate at least one information element at least until the trigger event is detected at the user equipment.

Clause 54. The method of any of clauses 48 to 53, wherein the trigger event is marked by a last number of modification periods before a time at which the first NTN cell stops serving the geographic area.

Clause 55. The method of clause 54, wherein the time at which the first NTN cell stops serving the geographic area is indicated in the information elements with the assistance information for the first aerospace platform.

Clause 56. The method of clause 54 or clause 55, wherein the last number of modification periods is indicated in the information elements with the assistance information for the first aerospace platform.

Clause 57. The method of any of clauses 48 to 56, wherein the method further comprises receiving a paging message at the user equipment to cause the user equipment to acquire the separate at least one information element.

Clause 58. A computer-readable storage medium that is non-transitory and has computer-readable program code stored therein that, in response to execution by at least one processing circuitry, causes an apparatus to at least: schedule transmission of system information blocks (SIBs) including information elements with assistance information for a first aerospace platform, and a separate at least one information element with assistance information for a second aerospace platform, the first aerospace platform and the second aerospace platform configured to provide respectively a first non-terrestrial network (NTN) cell and a second NTN cell that are quasi-Earth-fixed cells serving a geographic area for limited periods of time; and cause a user equipment in the first NTN cell to acquire the separate at least one information element with the assistance information for the second aerospace platform, during a period of time the geographic area is served by the first NTN cell, before the geographic area is served by the second NTN cell.

Clause 59. The computer-readable storage medium of clause 58, wherein the SIBs include a SIB of one type that includes the information elements with the assistance information for the first aerospace platform, and a separate SIB of another type that includes the separate at least one information element with the assistance information for the second aerospace platform, and wherein causing the user equipment to acquire the separate at least one information element includes causing the user equipment to acquire the separate SIB that includes the separate at least one information element.

Clause 60. The computer-readable storage medium of clause 58 or clause 59, wherein causing the user equipment to acquire the separate at least one information element includes broadcasting the separate at least one information element for the user equipment to acquire on or after a trigger event during the period of time the geographic area is served by the first NTN cell.

Clause 61. The computer-readable storage medium of clause 60, wherein the computer-readable storage medium has further computer-readable program code stored therein that, in response to execution by the at least one processing circuitry, causes the apparatus to further detect the trigger event, and the separate at least one information element is broadcast only on or after the trigger event is detected.

Clause 62. The computer-readable storage medium of clause 60 or clause 61, wherein the separate at least one information element is broadcast before and after the trigger event is detected, and the user equipment is exempt from acquiring the separate at least one information element at least until the trigger event is detected at the user equipment.

Clause 63. The computer-readable storage medium of any of clauses 58 to 62, wherein the trigger event is marked by a last number of modification periods before a time at which the first NTN cell stops serving the geographic area.

Clause 64. The computer-readable storage medium of clause 63, wherein the time at which the first NTN cell stops serving the geographic area is indicated in the information elements with the assistance information for the first aerospace platform.

Clause 65. The computer-readable storage medium of clause 63 or clause 64, wherein the last number of modification periods is indicated in the information elements with the assistance information for the first aerospace platform.

Clause 66. The computer-readable storage medium of any of clauses 58 to 65, wherein the computer-readable storage medium has further computer-readable program code stored therein that, in response to execution by the at least one processing circuitry, causes the apparatus to further transmit a paging message to the user equipment to cause the user equipment to acquire the separate at least one information element.

Clause 67. A computer-readable storage medium that is non-transitory and has computer-readable program code stored therein that, in response to execution by at least one processing circuitry, causes an apparatus to at least: receive scheduling information for system information blocks (SIBs) at a user equipment, the SIBs including information elements with assistance information for a first aerospace platform, and a separate at least one information element with assistance information for a second aerospace platform, the first aerospace platform and the second aerospace platform configured to provide respectively a first non-terrestrial network (NTN) cell and a second NTN cell that are quasi-Earth-fixed cells serving a geographic area for limited periods of time; and acquire the separate at least one information element with the assistance information for the second aerospace platform, at the user equipment in the first NTN cell, during a period of time the geographic area is served by the first NTN cell, before the geographic area is served by the second NTN cell.

Clause 68. The computer-readable storage medium of clause 67, wherein the computer-readable storage medium has further computer-readable program code stored therein that, in response to execution by the at least one processing circuitry, causes the apparatus to further apply the assistance information for the second aerospace platform to switch the user equipment from the first NTN cell provided by the first aerospace platform, to the second NTN cell provided by the second aerospace platform.

Clause 69. The computer-readable storage medium of clause 67 or clause 68, wherein the SIBs include a SIB of one type that includes the information elements with the assistance information for the first aerospace platform, and a separate SIB of another type that includes the separate at least one information element with the assistance information for the second aerospace platform, and wherein acquiring the separate at least one information element includes the apparatus caused to acquire the separate SIB that includes the apparatus caused to the separate at least one information element.

Clause 70. The computer-readable storage medium of any of clauses 67 to 69, wherein the at least one information element is broadcast for the user equipment to acquire on or after a trigger event during the period of time the geographic area is served by the first NTN cell.

Clause 71. The computer-readable storage medium of clause 70, wherein the separate at least one information element is broadcast only on or after the trigger event is detected.

Clause 72. The computer-readable storage medium of clause 70 or clause 71, wherein the separate at least one information element is broadcast before and after the trigger event is detected, and the computer-readable storage medium has further computer-readable program code stored therein that, in response to execution by the at least one processing circuitry, causes the apparatus to further detect the trigger event at the user equipment that is exempt from acquiring the separate at least one information element at least until the trigger event is detected at the user equipment.

Clause 73. The computer-readable storage medium of any of clauses 67 to 72, wherein the trigger event is marked by a last number of modification periods before a time at which the first NTN cell stops serving the geographic area.

Clause 74. The computer-readable storage medium of clause 73, wherein the time at which the first NTN cell stops serving the geographic area is indicated in the information elements with the assistance information for the first aerospace platform.

Clause 75. The computer-readable storage medium of clause 73 or clause 74, wherein the last number of modification periods is indicated in the information elements with the assistance information for the first aerospace platform.

Clause 76. The computer-readable storage medium of any of clauses 67 to 75, wherein the computer-readable storage medium has further computer-readable program code stored therein that, in response to execution by the at least one processing circuitry, causes the apparatus to further receive a paging message at the user equipment to cause the user equipment to acquire the separate at least one information element.

Clause 77. An apparatus comprising means for performing the method of any of clauses 39 to 47.

Clause 78. A computer-readable medium comprising computer-readable program code that, in response to execution by at least one processing circuitry, causes an apparatus to perform the method of any of clauses 39 to 47.

Clause 79. A computer-readable storage medium comprising computer-readable program code that, in response to execution by at least one processing circuitry, causes an apparatus to perform the method of any of clauses 39 to 47.

Clause 80. A computer program comprising computer-readable program code that, in response to execution by at least one processing circuitry, causes an apparatus to perform the method of any of clauses 39 to 47.

Clause 81. An apparatus comprising means for performing the method of any of clauses 48 to 57.

Clause 82. A computer-readable medium comprising computer-readable program code that, in response to execution by at least one processing circuitry, causes an apparatus to perform the method of any of clauses 48 to 57.

Clause 83. A computer-readable storage medium comprising computer-readable program code that, in response to execution by at least one processing circuitry, causes an apparatus to perform the method of any of clauses 48 to 57.

Clause 84. A computer program comprising computer-readable program code that, in response to execution by at least one processing circuitry, causes an apparatus to perform the method of any of clauses 48 to 57.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising:
at least one memory configured to store computer-readable program code; and
at least one processing circuitry configured to access the at least one memory, and execute the computer-readable program code to cause the apparatus to at least:
schedule transmission of system information blocks (SIBs) including information elements with assistance information for a first aerospace platform, and a separate at least one information element with assistance information for a second aerospace platform, the first aerospace platform and the second aerospace platform configured to provide respectively a first non-terrestrial network (NTN) cell and a second NTN cell that are quasi-Earth-fixed cells serving a geographic area for limited periods of time; and
cause a user equipment in the first NTN cell to acquire the separate at least one information element with the assistance information for the second aerospace platform, during a period of time the geographic area is served by the first NTN cell, before the geographic area is served by the second NTN cell.

2. The apparatus of claim 1, wherein the SIBs include a SIB of one type that includes the information elements with the assistance information for the first aerospace platform, and a separate SIB of another type that includes the separate at least one information element with the assistance information for the second aerospace platform, and
wherein causing the user equipment to acquire the separate at least one information element includes causing the user equipment to acquire the separate SIB that includes the separate at least one information element.

3. The apparatus of claim 1, wherein causing the user equipment to acquire the separate at least one information element includes broadcasting the separate at least one information element for the user equipment to acquire on or after a trigger event during the period of time the geographic area is served by the first NTN cell.

4. The apparatus of claim 3, wherein the at least one processing circuitry is configured to execute the computer-readable program code to cause the apparatus to further detect the trigger event, and the separate at least one information element is broadcast only on or after the trigger event is detected.

5. The apparatus of claim 3, wherein the separate at least one information element is broadcast before and after the trigger event is detected, and the user equipment is exempt from acquiring the separate at least one information element at least until the trigger event is detected at the user equipment.

6. The apparatus of claim 1, wherein the trigger event is marked by a last number of modification periods before a time at which the first NTN cell stops serving the geographic area.

7. An apparatus comprising:
at least one memory configured to store computer-readable program code; and
at least one processing circuitry configured to access the at least one memory, and execute the computer-readable program code to cause the apparatus to at least:
receive scheduling information for system information blocks (SIBs) at a user equipment, the SIBs including information elements with assistance information for a first aerospace platform, and a separate at least one information element with assistance information for a second aerospace platform, the first aerospace platform and the second aerospace platform configured to provide respectively a first non-terrestrial network (NTN) cell and a second NTN cell that are quasi-Earth-fixed cells serving a geographic area for limited periods of time; and
acquire the separate at least one information element with the assistance information for the second aerospace platform, at the user equipment in the first NTN cell, during a period of time the geographic area is served by the first NTN cell, before the geographic area is served by the second NTN cell.

8. The apparatus of claim 7, wherein the SIBs include a SIB of one type that includes the information elements with the assistance information for the first aerospace platform, and a separate SIB of another type that includes the separate at least one information element with the assistance information for the second aerospace platform, and
wherein acquiring the separate at least one information element includes the apparatus caused to acquire the separate SIB that includes the apparatus caused to the separate at least one information element.

9. The apparatus of claim 7, wherein the at least one information element is broadcast for the user equipment to acquire on or after a trigger event during the period of time the geographic area is served by the first NTN cell.

10. The apparatus of claim 9, wherein the separate at least one information element is broadcast only on or after the trigger event is detected.

11. The apparatus of claim 9, wherein the separate at least one information element is broadcast before and after the trigger event is detected, and the at least one processing circuitry is configured to execute the computer-readable program code to cause the apparatus to further detect the trigger event at the user equipment that is exempt from acquiring the separate at least one information element at least until the trigger event is detected at the user equipment.

12. The apparatus of claim 7, wherein the trigger event is marked by a last number of modification periods before a time at which the first NTN cell stops serving the geographic area.

13. A method comprising:
scheduling transmission of system information blocks (SIBs) including information elements with assistance information for a first aerospace platform, and a separate at least one information element with assistance information for a second aerospace platform, the first aerospace platform and the second aerospace platform configured to provide respectively a first non-terrestrial network (NTN) cell and a second NTN cell that are quasi-Earth-fixed cells serving a geographic area for limited periods of time; and
causing a user equipment in the first NTN cell to acquire the separate at least one information element with the assistance information for the second aerospace platform, during a period of time the geographic area is served by the first NTN cell, before the geographic area is served by the second NTN cell.

14. The method of claim 13, wherein the SIBs include a SIB of one type that includes the information elements with the assistance information for the first aerospace platform, and a separate SIB of another type that includes the separate at least one information element with the assistance information for the second aerospace platform, and
wherein causing the user equipment to acquire the separate at least one information element includes causing the user equipment to acquire the separate SIB that includes the separate at least one information element.

15. The method of claim 13, wherein causing the user equipment to acquire the separate at least one information element includes broadcasting the separate at least one information element for the user equipment to acquire on or after a trigger event during the period of time the geographic area is served by the first NTN cell.

16. The method of claim 13, wherein the trigger event is marked by a last number of modification periods before a time at which the first NTN cell stops serving the geographic area.

17. A method comprising:
receiving scheduling information for system information blocks (SIBs) at a user equipment, the SIBs including information elements with assistance information for a first aerospace platform, and a separate at least one information element with assistance information for a second aerospace platform, the first aerospace platform and the second aerospace platform configured to provide respectively a first non-terrestrial network (NTN) cell and a second NTN cell that are quasi-Earth-fixed cells serving a geographic area for limited periods of time; and
acquiring the separate at least one information element with the assistance information for the second aerospace platform, at the user equipment in the first NTN cell, during a period of time the geographic area is served by the first NTN cell, before the geographic area is served by the second NTN cell.

18. The method of claim 17, wherein the SIBs include a SIB of one type that includes the information elements with the assistance information for the first aerospace platform, and a separate SIB of another type that includes the separate at least one information element with the assistance information for the second aerospace platform, and
wherein acquiring the separate at least one information element includes acquiring the separate SIB that includes the separate at least one information element.

19. The method of claim 17, wherein the at least one information element is broadcast for the user equipment to acquire on or after a trigger event during the period of time the geographic area is served by the first NTN cell.

20. The method of claim 17, wherein the trigger event is marked by a last number of modification periods before a time at which the first NTN cell stops serving the geographic area.
